(19) United States
(12) Patent Application Publication
(10) Pub. No.: US 2009/0106840 A1
(43) Pub. Date: Apr. 23, 2009

(54) Certification Of E-Mails With Embedded Code

(76) Inventors: Daniel T. Dreymann, Palo Alto, CA (US); Stephan Brunner, Lafayette, CA (US); Anh Vo, Sunnyvale, CA (US); Yoel Gluck, Mountain View, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/254,831

(22) Filed: Oct. 20, 2008

Related U.S. Application Data
(60) Provisional application No. 60/980,992, filed on Oct. 18, 2007.

(51) Int. Cl. G06F 11/00

(52) U.S. Cl. 726/23

(57) ABSTRACT

Certification of embedded content in e-mail is provided. A sender wishing to have code certified for inclusion in e-mail sends the code to a token authority. A code verification engine acting automatically or in conjunction with an analyst examines the code to determine whether it poses a risk of harm to e-mail recipients. If not, the token authority issues a certificate for the embedded content. The mail sender sends e-mail to recipients including the embedded content, and the certification is sent in conjunction with the content itself. A mailbox provider inspects the received e-mail to determine whether it includes embedded content and, if so, whether a certification is attached that the embedded content is not harmful. If not, or if the message includes uncertified content in addition to certified content, then the message is rejected, or delivered with a warning that certification is not present.

### CROSS-REFERENCE TO RELATED APPLICATIONS

This application claims the benefit of U.S. Provisional Application No. 60/980,992, filed Oct. 18, 2007 and incorporated by reference herein in its entirety.

This application is related to U.S. patent application Ser. No. 11/743,151, filed on May 2, 2007, which is incorporated by reference herein in its entirety. This application is also related to U.S. patent application Ser. No. 11/421,748, filed on Jun. 1, 2006, which is incorporated by reference herein in its entirety.

### BACKGROUND OF THE INVENTION

1. Field of the Invention

The present invention relates generally to delivery of e-mail. In particular, the present invention is directed toward certification of e-mails that include embedded content.

2. Description of Background Art

A substantial amount of electronic mail (e-mail) messages received by e-mail account holders is unsolicited, unwanted and unappreciated, and is popularly referred to as “spam”. Efforts to control spam range from increasingly sophisticated e-mail filtering systems to legislation such as the “Controlling the Assault of Non-Solicited Pornography and Marketing Act of 2003”. Regrettably, spammers have not been deterred, and the flood of e-mails continues.

Some e-mail, both legitimate and of the spam variety, includes embedded content such as JavaScript, Adobe Flash or other types of executable code within the message. While executable code is generally included in messages for legitimate purposes, such as to add improved functionality and appearance to the message, malicious code can cause damage to the recipient's computer, and to computers of those to whom the message is forwarded.

Consequently, many mailbox providers block rich media such as JavaScript, Adobe Flash, and other executable code in incoming e-mail messages by stripping the content from the message before delivering the message to the mailbox owner. At the same time, however, there is high demand for rich capabilities in e-mail, including video, animation, filling of forms, and other interactive features.

### SUMMARY OF THE INVENTION

The present invention enables certification of embedded content sent by an e-mail sender to an e-mail recipient. A person or other entity (known henceforth as a mail sender, or simply a sender) that wishes to have content such as JavaScript, Flash or other code certified for inclusion in e-mail sends the code to a token authority. A code verification engine acting automatically or in conjunction with a human analyst examines the received code to determine whether it poses a risk of harm to e-mail recipients. If no risk of harm is found, then the token authority issues a certificate for the embedded content, in one embodiment in the form of a digital signature. When the mail sender wishes to send e-mail to recipients including the certified embedded content, the certification is sent in conjunction with the content itself. A mailbox provider acting on behalf of the e-mail recipient then inspects the received e-mail to determine whether it includes any embedded content and, if so, whether a certification is attached that the embedded content is not harmful, i.e. that it is certified content. If such a certification exists, the mailbox provider delivers the e-mail message including the embedded content to the mailbox owner. If not, or if the message additionally includes uncertified embedded content, then the message is either rejected, or is delivered with a warning that a certification is not present, or is delivered with the uncertified embedded code stripped from the message.

In some embodiments, once the token authority has determined that the code is not malicious, the code is stored on a code hosting server administered by the token authority, and in alternative embodiments by the mailbox provider or another trusted party. In these embodiments, the mail sender sends an e-mail which, rather than including the embedded content instead includes an IFrame referencing the content stored on the code hosting server. Because the referenced code is stored by a trusted party, it can also be trusted. In one embodiment, the IFrame is itself certified by the token authority.

In one embodiment, the embedded content certification coexists with a system for certifying the identify of the e-mail sender.

### BRIEF DESCRIPTION OF THE DRAWINGS

FIG. 1 is a block diagram of the overall architecture of an embodiment of the present invention.

FIG. 2 is a flowchart illustrating a method of unsubscribing from an e-mail distribution list in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The use of tokens, also known as stamps, is an economically-driven solution to address the damage caused by spam and fraudulent emails and their negative after-effects such as false positives, identity theft, spoofed messages and viruses. In addition, using tokens shifts the burden of the high cost of fighting spam from the recipients to the senders of e-mail. The use of tokens identifies and labels the “good” mail with tokens paid for by responsible high-volume senders who are subject to sender-level accreditation and made accountable for following e-mail best practices. Various stamping systems and methods are in conventional use, for example as described in U.S. Pat. No. 5,999,967 to Sundsted, which is incorporated by reference herein in its entirety.

Because e-mail recipients are flooded with increasing amounts of irrelevant and often harmful e-mail, a typical response by a recipient is to simply delete e-mails that are not from friends, family or other recognized senders rather than suffering through reading spam, or worse, having their computer infected with a virus or other malicious code. Previous approaches including those described above have enabled mail senders to identify themselves as legitimate by agreeing to abide by certain terms of use, and in exchange, having their legitimacy conveyed to e-mail recipients, for example by use of a differentiated e-mail icon in a recipient's inbox. Senders typically pay a fee for this service to a third party. The third party, referred to here is a token authority, digitally signs the e-mail message on behalf of the sender, and the signature is validated at the receiving end to ensure that the e-mail has not been tampered with.

In addition to the above, the present invention enables senders to include certified embedded content such as JavaScript and Flash in the body of an e-mail. Because the embedded content is certified by the token authority as being safe, mailbox providers can comfortably allow the content to reach the recipient's mailbox instead of stripping it out or otherwise blocking it.

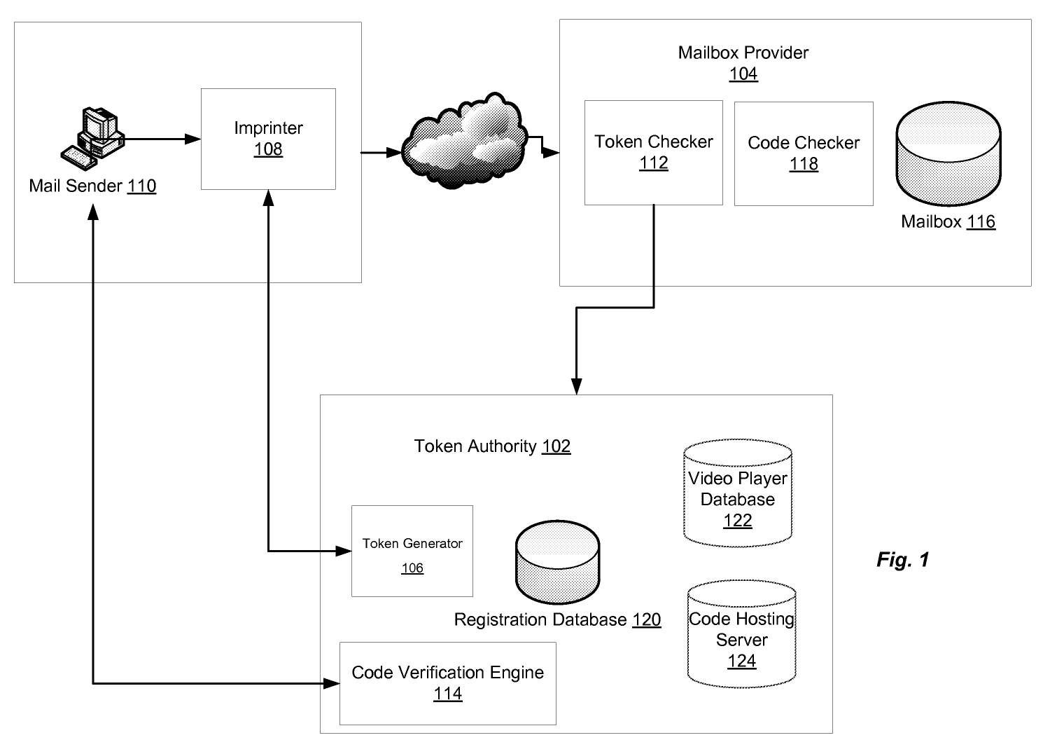

FIG. 1 is a block diagram that illustrates the interaction of various components of an e-mail token and embedded code verification system. FIG. 1 includes a token authority 102 having a token generator 106, a code verification engine 114, registration database 120, video player database 122 and code hosting server 124; a mail sender 110 having an imprinter 108; and a mailbox provider 104, providing a mailbox 116 for an e-mail recipient, and having a token checker 112 and code checker 118.

Mail sender 110 sends e-mails to one or more recipients—typically to a large number of recipients, though for clarity of description we assume a single recipient in this instance without any loss of generality. When mail sender 110 wants to send an e-mail that has an attached token, the e-mail is transmitted to imprinter 108, which creates appropriate token header fields as described below, calculates a hash of the message, and sends the hash to token generator 106, which signs, optionally inserts sender information, and returns the token. After receiving a token back from token generator 106, imprinter 108 then sends the e-mail to its intended recipient.

When token generator 106 receives the hash from imprinter 108, it verifies that the mail sender 110 is authorized to obtain a token—for example, it verifies that the mail sender 110 is up to date on payments, has not exceeded a quota, has tokens in his account, has not violated any business rules that limit his ability to obtain tokens, etc. In one embodiment, imprinter 108 connects in real time to token authority 102 to have token generator 106 perform the verification; alternatively, outgoing e-mails can be queued and the verification process can take place during a batch update when connection to token authority 102 is available.

To include embedded code in the e-mail, mail sender 110 provides a copy of the embedded code to code verification engine 114 of token authority 102. In one embodiment, the proposed code is provided to code verification engine 114 ahead of time—that is, at some time prior to the initiation of transmission from the mail sender to the mail recipient, in order to account for any latency in the code verification process. In an alternative embodiment, the code is provided to code verification engine 114 in real time. Code verification engine 114 analyzes the code to confirm that it is not malicious, i.e., that it does not pose a risk of harm to software or hardware of mail recipients. In one embodiment, code verification engine 114 operates with the assistance of human analysts, who review to the code to ascertain that the code is harmless, makes no attempt to overtake a recipient's resources, or to perform tasks other than advertised, e.g., to check the validity of data fields entered by the user. In an alternative embodiment, code verification engine 114 automatically analyzes all or portions of the code and compares it against known fragments of malicious code to determine whether there is a match between the submitted code and any known malicious code. In one embodiment, the embedded content includes a video player and associated code, e.g., JavaScript, required to launch the player. Once code verification engine 114, either automatically or with human assistance, determines that the submitted code is not malicious, the code is signed by the token authority 102 using a digital signature. The signed token associated with the embedded code is then returned to mail sender 110. For any subsequent e-mails in which mail sender 110 wishes to include the same code embedded in an e-mail, the mail sender 110 need only apply the same signature to the e-mail. Provided the embedded content has not changed since the token was generated, the signature will still be valid. In this manner, a portion of the e-mail can include content that changes from message to message, while another portion can include the pre-approved embedded code.

In one embodiment, once token authority 102 has determined that the code is not malicious, the code is stored on code hosting server 124. In the illustrated embodiment of FIG. 1, code hosting server 124 is administered by token authority 102; in alternative embodiments it may be administered by mailbox provider 104, or by another trusted party. Mail sender 110 then sends an e-mail that includes an IFrame referencing the content stored on the code hosting server, in lieu of the code itself. Because the referenced code is stored by a trusted party, it can also be trusted. In one embodiment, the IFrame is itself certified by token authority 102.

Once token generator 106 determines that mail sender 110 is authorized to use a token as described above, it generates a token and provides the token to imprinter 108 to allow the e-mail to be sent.

The e-mail then travels in a conventional method to a mailbox provider 104. Upon arrival, token checker 112 examines the token to determine whether it has a valid signature. If the token is not valid, the message may have been tampered with or otherwise compromised, and the e-mail is either rejected outright or treated by mailbox provider 104 as if it did not have a token to begin with. If the e-mail includes certified embedded code, code checker 118 examines the secondary signature to determine that it is valid. If it is not valid, this indicates an error or tampering, and the e-mail is rejected, delivered with its embedded content stripped, or delivered with a warning. In one embodiment, a mailbox provider 104 also rejects or delivers with a warning any e-mail message that includes embedded code but does not contain a valid signature certifying the code as safe. If the e-mail includes a valid certificate, code checker 118 next sanitizes the data part and checks the remainder of the messages to identify any code infusions-known character string that could potentially change the behavior of the code. Malicious code including known character strings are typically publicized for reference purposes, for example by CERT at Carnegie Mellon University. Code checker 118 thus removes any JavaScript, object tags or embed tags not located within the approved and certified embedded code. If no bad characters are identified, the e-mail is placed in the user's mailbox 116. In one embodiment, the e-mail includes a flag instructing the user's client software not to block the embedded content. If the message instead contains an IFrame referencing embedded content located on code hosting server 124, then code checker 118 allows the reference to remain in the message, and it will then be used to access the code on behalf of the recipient when the message is displayed.

Systems and methods for tokenizing e-mail are further described in United States Patent Publication No. US 2006/0277597 μl, filed Jun. 1, 2006, and application Ser. No. 11/566,013, filed Dec. 1, 2006, both of which are incorporated herein by reference in their entirety.

E-mail is typically accessed either via a web interface or by use of a client application. Web interfaces allow an account holder to check her e-mail from any location simply by accessing the web. Many mailbox providers provide web interfaces for e-mail access, including Microsoft Hotmail, Yahoo! Mail, Google Gmail, and America Online. Alternatively, client-side applications such as Microsoft Outlook, Microsoft Outlook Express, and Mozilla Thunderbird may also be used by account holders, and often provide more robust e-mail editing and storage features than are found on web clients.

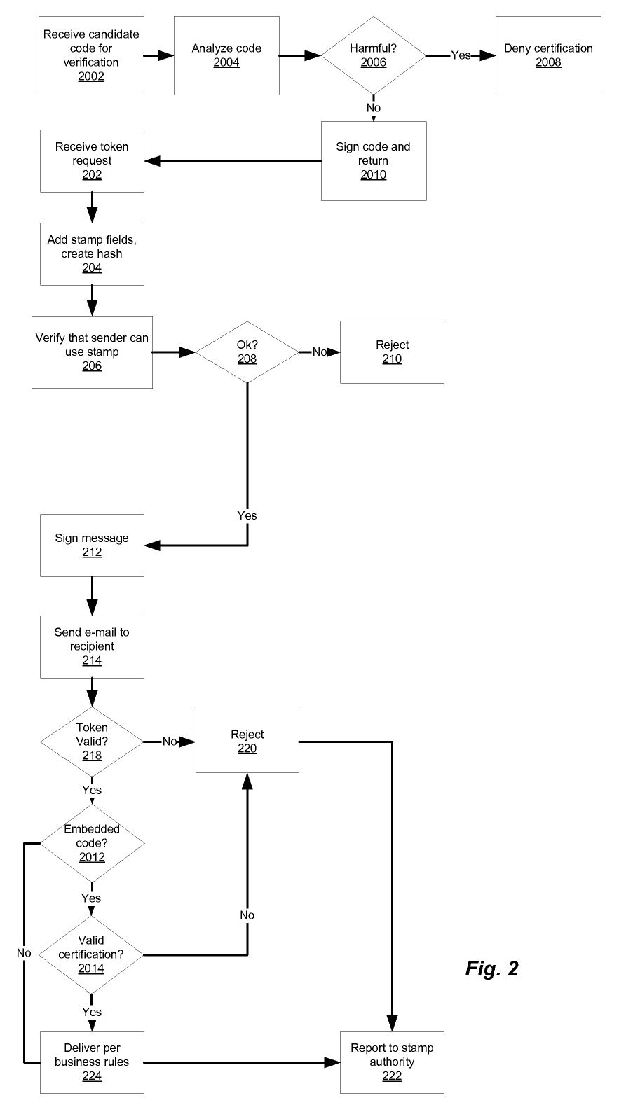

FIG. 2 illustrates a method of sending tokenized e-mail with sender validation and embedded code certification in accordance with an embodiment of the present invention.

Token authority 102 receives 2002 from mail sender 110 the candidate portion of code that the sender intends to embed in future messages. Code verification engine 114 then analyzes 2004 the code, either with or without human assistance, to determine 2006 whether it is harmful. If the code is determined to be potentially harmful, token authority 102 rejects 2008 the code, denying it certification. If the code is determined to be safe, then token authority 102 signs 2010 the code and returns it to mail sender 110 for insertion into subsequent e-mails.

Mail sender 110 then sends 202 a message hash to imprinter 108 and requests a token. In one embodiment the message includes embedded content and carries the certification previously issued by token authority 102.

In one embodiment, a token is unique for each message, and is a cryptographic object contained within the header of the e-mail message. The token includes a variety of header fields, for example:

X-StampAuthority-Rcpto: joe@example.com
X-StampAuthority-Reply-To: mary@example.com
X-StampAuthority-Sender: amy@example.com
X-StampAuthority: 1; i=”12345”;
s=“0000001C0000001C0001000141D3237600000001000000-
1300000002”;
e=”20040612T123256”; d=”20040608T082310”; o=“342AC5”; t=“2”;
h=“4Io7sVcs55HmRWhSE3QucCKHc1U=”;
f=”QmlnIFRydWNrcyBvZmZlcnNAYmlndHJ1Y2tzlmNvbQ==”;
b=“6MdkylkSixEEfv7oh38fO6O2uic=”;
X-StampAuthority-Entity: First Street Bank, Inc.
X-StampAuthority-Sig:
MfowCwYJKoZIhvcNAQEBA0sAMEgCQQDNZ+V7wcxLqyAQR
iHtMySKtD5UfT/rdFzaGehCmp8QECDKhPKqRC2EMbvBXZVdNIo-
500yrPayUKBYxfj
Mcxc5AgMBAAE=

The particular header fields chosen to implement the present invention may be determined according to the needs of the implementer.

Imprinter 108 also adds a header transit hash to the message, represented by the “h=” string in the example shown above, and a body transit hash, represented by the “b=” string in the example shown above. In one embodiment, the “h” parameter contains the base64 encoded SHA1 hash of data specific to the email message stamped. The inclusion of the hash in the token binds the token to the message headers, and it protects message headers during transit by allowing filters to detect if message headers have been modified. The “b” parameter contains the base64 encoded SHA1 hash of data specific to the email message. The inclusion of the hash in the token binds the token to the message body, and it protects the message body during transit by allowing filters to detect if the message has been modified.

Returning to FIG. 2, once the token fields and hash are created 204, imprinter 108 forwards the hash to token generator 106, which verifies 206 that the sender is authorized to obtain a token. A mail sender 110 may be ineligible to obtain a token if, for example, the sender has become delinquent or has violated its terms of agreement with token authority 102.

If 208 the sender is not entitled to a token, token generator 106 will reject 210 the message. If the mail sender 110 is allowed to obtain a token, token generator 106 adds 212 its signature to the header and returns the message to imprinter 108, which then sends 214 the message to the message's specified recipient.

In one embodiment, token generator 106 has a private/public key pair generated in a conventional manner. Token generator 106 uses the parameters such as those listed below and its private key to create a transit signature using a cryptographic algorithm, for example RSASSA-PKCS1-V1_{—}5. The parameters used by the token generator 106 to create the token in one embodiment are: a version number of the token protocol; a unique ID for that token; an indication of a token type (adult, commercial, video, embedded content, etc.); a hash of the message created from the message and the token fields (obtained from imprinter 108 as described above); Sender: information (obtained from the message envelope by imprinter 108); and RCPT TO: information (obtained from the message envelope by imprinter 108). Other parameters could also be used as deemed appropriate by an implementer of such a system.

The creation of the transit signature in one embodiment first involves the creation of a hash of all of the fields being signed (which includes all token fields and the message hash), and then the signing algorithm is implied. Thus, there may be multiple hash operations being performed; the first operation is a hash of the entire message and the token fields, or separately, a hash of the message body and a hash of the header fields, which are then inserted as one or more fields in the token. These fields, along with all other token authority 102 fields, are then hashed in a second hash operation, the value of which is then signed using the public key certificate of token authority 102. In this way, these token authority 102 fields can be validated without the entire message being present. In one embodiment, the above parameters including the transit signature, combined with the certificate, create a fully-formed token. Those of skill in the art will appreciate that in alternative embodiments, more or fewer hashes may be used.

When the e-mail is received by mailbox provider 110, token checker 112 checks the signature on the token to determine whether 218 it is valid.

In one embodiment, the certificate is verified by token checker 112 as follows. Token checker 112 uses the token authority's public key, which is publicly available. Next, token checker 112 determines a hash of the fields in the certificate. Token checker 112 then takes the hash, the token authority public key, and the certificate signature and performs a signature verification operation to check whether the signature of the certificate (and hence the certificate) is valid.

If the certificate is not valid, token checker 112 either rejects 220 the message outright, or delivers it to the mailbox 116 of the specified recipient, but preferably with an indication that it does not have an accompanying valid certificate. For example, messages without valid certificates are displayed in one embodiment without a certification icon in order to distinguish them from certificated messages. Alternatively, if the message is rejected, additional steps can be taken, for example the sender of the message could be notified that a message was received claiming to be from the sender 104 but was not successfully validated. Preferably, a report is also made 222 to the token authority 102.

If 218 the certificate is valid, then mailbox provider 110 next determines 2012 whether the e-mail includes embedded code. If not, the e-mail is delivered 224 by mailbox provider 110 to the mailbox 116 of the specified recipient, subject to any other delivery rules that the mailbox provider or owner may have set up for mail handling—for example, messages containing embedded code may be blocked in all cases. If the e-mail does include embedded code, code checker 118 determines 2014 whether the message includes a valid certification that the embedded content is safe. If the message includes such a valid certification, it is delivered 224 as described above. Alternatively, if the message does not include a valid certification, the message is rejected 220 outright, or delivered it to the mailbox 116 of the specified recipient, but with an indication that it does not have an accompanying valid certificate for the embedded content, or is stripped of its embedded content and then delivered. In one embodiment, a report is also made 222 to the token authority 102 indicating the result of the analysis, so that the token can be cancelled and not reused.

In an alternative embodiment, sender validation is omitted, and token authority 102 certifies only that the embedded content is not malicious, as described above. That is, the described methodology and system for certifying embedded content does not rely on also validating sender information such as the sender's stated From: address.

We consider now an example in which a mail sender 110 plans to send an e-mail message to a recipient, and plans to include video content in the body of the message. For example, the e-mail may be an advertisement for a movie, and a trailer for the movie may be shown in the body of the e-mail. To achieve this result, the mail sender uses code such as JavaScript to specify a video player that will be used in the body of the e-mail, and also supplies a location, such as a URL, of the content to be displayed in the player.

A first step for mail sender 110 (or its affiliate) is to obtain certification for the code that will be embedded in the message itself, e.g., the video player and the code required to launch it. In one embodiment, token authority 102 provides access to pre-approved video players. Alternatively, mail sender 110 submits the video player and JavaScript (or other) launch code to token authority 102. Code verification engine 114 examines the code, either automatically or manually or a combination of the two, and determines whether it is safe for inclusion. If the code is not safe, it is rejected and mail sender 110 is so notified. If it is deemed safe, then the binary code for the video player is stored in video player database 122. Once the code has been deemed safe, token generator 106 generates and signs a tag including the code. In one embodiment, the public key to verify the signature is included in the certificate. The certificate itself is signed by the token authority 102. An example of a certificate is:

```
<GoodmailSystems-Certified
  ver = “1”
  cert =
“MIICMTCCARkCAWcwDQYJKoZIhvcNAQEFBQAwNjE0MDIGA1UEAxMrU ... ”
  sig =
“LdqwcLLBYiJYGvDusNzBE2tE+NxmiYugRPDmalPTtghCML0dVMOX9IA
  xWW2HLa99Wye+sKYtuYk9nG+mscgf+u8BwOXEehOBTNlMeE/VxuCmdc
  9x3Uubck26iZx+NWpO“ >
<script src=“flowplayer.js” type=“text/javascript”></script>
        <script language=“JavaScript”
      type=“text/javascript”>
  function displayAllVideoPlayers( ) {
  // Loop through all player-params tags and
  // start the player for each of them
  var gmsvideoElements = document.getElementsByTagName(
  ‘player-params’);
    for (var i = 0; i < gmsvideoElements.length; i++) {
    displayVideoPlayer(document.getElementById(
    gmsvideoElements[i].parentNode.id),
    gmsvideoElements[i].getAttribute(“videofile”),
    gmsvideoElements[i].getAttribute(“width”),
    gmsvideoElements[i].getAttribute(“height”),
    gmsvideoElements[i].getAttribute(
    “controlbarbackgroundcolor”),
    gmsvideoElements[i].getAttribute(“autoplay”),
    gmsvideoElements[i].getAttribute(“autobuffering”),
    gmsvideoElements[i].getAttribute(“initialscale”));
    }
  }
  function displayVideoPlayer(gmsvideoDiv, videoFileURL,
widthSetting,
    heightSetting, controlBarBackgroundColorSetting,
    autoPlaySetting, autoBufferingSetting, initialScaleSetting)
  {
    // Call flow javascript to start a player
    flashembed(gmsvideoDiv.id, {
  src:‘http://b105.qa.goodmail.com/flowplayer/Player.swf’,
    width: widthSetting,
    height: heightSetting}, {
    config: {
      autoPlay: autoPlaySetting,
      autoBuffering: autoBufferingSetting,
      controlBarBackgroundColor:
      controlBarBackgroundColorSetting,
      initialScale: initialScaleSetting,
      videoFile: videoFileURL
      }
    });
    return 0;
  }
  // Start player for each player-params tag
  displayAllVideoPlayers( );
  //-->
  </script>
  <\GoodmailSystems-Certified>
```

In one embodiment, token authority 102 updates the mail sender's account in registration database 120 to indicate the issuance of the certification.

Note that token authority 102 does not analyze the content of any video that might be shown by the player in the body of the e-mail, nor is it even aware of the location of the content.

Mail sender 110 next creates an e-mail message to be sent to one or more recipients, and inserts the certified tag created by token authority 102. The sender also adds a tag containing any required run-time parameters needed by the video player, such as video scaling, volume and auto-play settings; and the URL of the video content. For example,

```
<div id=‘movie1’>
  <player-params
  videofile=‘http://blip.tv/file/get/filename.flv’
  width=400
  height=290
  controlbarbackgroundcolor=‘0x2e8860’
  autoplay=1
  autobuffering=1
  initialscale=‘scale’/>
</div>
```

Imprinter 108 then requests a token from token authority 102, and sends the certified e-mail to mailbox provider 104. In one embodiment, the token has an associated class that indicates to the receiving checker that certified embedded content is included in the message.

When token checker 112 receives the e-mail, it checks the token class to determine whether the message contains certified embedded content. If not, the e-mail token is validated as described above and, if valid, delivered to mailbox 116 of the recipient. If the token class indicates that the message does contain certified embedded content, then after the e-mail token is validated, code checker 118 validates the certificate and digital signature in the certified embedded tag within the message body. If the certified embedded tag is not valid, then the message is rejected, the embedded content is stripped, or some other action determined by mailbox provider 104 is taken. If the certificate is valid, code checker 118 then scans the message body for any JavaScript, object tags or embed tags that are outside of the certified tag portion of the message. If any are found, the message is again treated as not safe by mailbox provider 104, or alternatively the code outside of the certified portion is stripped, while the certified code is left intact. This prevents mail sender 110 from inserting additional un-validated code into the message. In one embodiment, if the certificate is valid and no wayward code is found in the message, code checker 118 adds a header field to indicate to mailbox provider 104 that the embedded content is safe. Mailbox provider 104 then deposits the message in mailbox 116 with the code intact.

In one embodiment, when the recipient opens a message containing certified embedded content, the mail client displays the message and begins playing the content specified in the parameters tag. In an alternative embodiment, the recipient manually activates playing of the content. In one embodiment, the content is played with muted sound, while in an alternative embodiment, sound is turned on by default.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the token generator 106, code checker 118 and so forth may be provided in many or one module.

Some portions of the above description present the feature of the present invention in terms of algorithms and symbolic representations of operations on information. These algorithmic descriptions and representations are the means used by those skilled in the art of e-mail security to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for certifying embedded content in an electronic mail message, the method comprising:
receiving from an e-mail sender an item of proposed content to be certified, the proposed content including code for affecting the behavior of a computer;
determining that the included code is not malicious code; and
responsive to the determination, providing a certification to the e-mail sender that the code is not malicious code.

2. The method of claim 1 wherein the included code is JavaScript code.

3. The method of claim 1 wherein the proposed content includes an object tag.

4. The method of claim 1 wherein the proposed content specifies indicia of a video player.

5. The method of claim 4 further comprising receiving code for executing the indicated video player.

6. The method of claim 5 further comprising storing the received code in a video player database.

7. The method of claim 4 wherein the indicated video player is one selected by the e-mail sender from among a plurality of available video players.

8. The method of claim 1 wherein the included code causes the computer to display a video.

9. The method of claim 1 wherein the included code causes the computer to play audio.

10. The method of claim 1 wherein determining that the included code is not malicious code further comprises:
automatically routing the code to a human evaluator; and
receiving an indication from the evaluator that the code is not malicious.

11. The method of claim 1 wherein determining that the included code is not malicious further comprises:
comparing a portion of the included code to a set of known malicious code fragments; and
responsive to the comparison not resulting in a match, determining that the included code is not malicious.

12. The method of claim 1 wherein providing the certification that the code is not malicious further comprises:
providing a digital signature associated with the proposed content.

13. The method of claim 12 further comprising providing a second digital signature usable to validate the first digital signature.

13. A method for certifying embedded content in an electronic mail message, the method comprising:
providing an item of proposed content to be certified, the proposed content including code for affecting the behavior of a computer;
receiving a certification of the proposed content;
creating an electronic mail message, the message including the certified content; and
transmitting the electronic mail message to an addressee of the message.

14. A method for displaying certified content in an electronic mail message, the method comprising:
receiving an electronic mail message having embedded content;
validating a certificate associated with the embedded content; and
responsive to the certificate being valid, displaying the embedded content.

15. The method of claim 14 further comprising:
responsive to the certificate not being valid, rejecting the electronic mail message.

16. The method of claim 14 further comprising:
responsive to the certificate not being valid, removing the embedded content from the message; and
displaying the message.

17. The method of claim 14 wherein the embedded content has a first portion and a second portion and the certificate is associated only with the first portion, the method further comprising:
removing the second portion of the embedded content from the message; and
displaying the first portion of the embedded content.

18. The method of claim 14 wherein the certificate is signed using a digital signature and the method further comprising validating the digital signature.

19. A system for certifying embedded content in an electronic mail message, the system comprising:
a code verification engine adapted to receive from an e-mail sender an item of proposed content to be certified, the proposed content including code for affecting the behavior of a computer, and further adapted to determine that the included code is not malicious code; and
a token generator, coupled to the code verification engine, adapted to provide a certification to the e-mail sender that the code is not malicious code.

20. The system of 19 wherein the proposed content specifies indicia of a video content player.

21. The system of 19 further comprising a video player database coupled to the code verification engine and including code for executing the video content player indicated by the proposed content.

22. The system of claim 19 wherein the token generator is further adapted to receive indicia of an electronic mail message from the e-mail sender that includes the proposed content and to generate a token certifying the electronic mail message and return the generated token to the e-mail sender.

23. A computer program product having a computer-readable storage medium having computer executable code for certifying embedded content in an electronic mail message, the code adapted to perform steps comprising:
receiving from an e-mail sender an item of proposed content to be certified, the proposed content including code for affecting the behavior of a computer;
determining that the included code is not malicious code; and
responsive to the determination, providing a certification to the e-mail sender that the code is not malicious code.

24. A method for certifying embedded content in an electronic mail message, the method comprising:
receiving from an e-mail sender an item of proposed content, the proposed content including code for affecting the behavior of a computer;
determining that the included code is not malicious code;
storing the proposed code;
receiving a request on behalf of an email recipient for the stored proposed code; and
providing the stored proposed code in response to the request.

25. The method of claim 24 further comprising providing a certification to the e-mail sender that the code is not malicious code.
